(19) United States
(12) Patent Application Publication
(10) Pub. No.: US 2023/0250244 A1
(43) Pub. Date: Aug. 10, 2023

(54) KENAF-POLYOLEFIN COMPOSITES AND METHODS OF MAKING

(71) Applicant: Sharina Killingsworth, Edmond, OK (US)

(72) Inventor: Sharina Killingsworth, Edmond, OK (US)

(21) Appl. No.: 17/778,933

(22) PCT Filed: Dec. 4, 2020
(86) PCT No.: PCT/US2020/063250

§ 371 Date: May 23, 2022

Related U.S. Application Data
(60) Provisional application No. 62/943,634, filed on Dec. 4, 2019.

(51) Int. Cl. C08J 5/04; C08L 23/06; C08L 23/12; C08J 3/22

(52) U.S. Cl. CPC C08J 5/045; C08L 23/06; C08L 23/12; C08J 3/226; C08L 2205/16; C08J 2403/02; C08J 2323/06; C08J 2323/12; C08J 2405/00

(57) ABSTRACT

A composition comprises woody core fibers from hemp, kenaf, jute and/or flax that are optionally coated with one or more saccharides or polysaccharides and dispersed in a matrix of polyolefin.

### CROSS REFERENCE TO RELATED APPLICATION/INCORPORATION BY REFERENCE STATEMENT

This application claims priority to U.S. Provisional Application Ser. No. 62/943,634 filed Dec. 4, 2019, the entirety of which is expressly incorporated herein by reference.

### 1. FIELD OF THE INVENTION

The inventive concepts disclosed and claimed herein relate generally to polymer composite materials, and more particularly, but not by way of limitation, to cellulosic fiber reinforced polymers.

### 2. BACKGROUND OF THE INVENTION

The use of cellulosic fillers as additives for both thermoplastic and thermosetting resins has gained attention. Such fillers have included wood pulp, the shells of peanuts or walnuts, corn cobs, rice hulls, vegetable fibers, and grasses. The cost advantages of cellulosic fibers provided initial incentive for their use in plastics. Natural fibers were also intended to yield a lighter composite compared to fiberglass reinforced polymers. The renewable and biodegradable qualities of natural fibers have sparked renewed interest in cellulosic fiber-plastic composites.

Kenaf, Hibiscus cannabinus, is a plant native to southern Asia. Kenaf is a bast fiber plant comprised of two main components that can be leveraged for industrial use. The first is the bast fiber of the plant located just inside the outer layer of the stalk. The kenaf fiber has historically been used to make rope, twine, course cloth and other woven items. The second useful part of the plant is the core. The core, known as kenaf hurd, is woody in nature and is typically used for animal bedding and potting media.

The bast constitutes about 40% of the plant and contains slender fiber cells about 2-6 mm long with a thick (6.3 μm) cell wall. The core is about 60% of the plant and has relatively thick (˜38 μm) but short (0.5 mm) and thin-walled (3 μm) fiber cells.

To make kenaf a successful crop, it should be incorporated into value-added products. Kenaf bast fiber is known to have potential as a reinforcing fiber in thermoplastic composites because of its toughness and high aspect ratio in comparison to other fibers. The main disadvantage encountered during the addition of natural fibers, including kenaf bast fiber into a polymer matrix, is the lack of good interfacial adhesion between the polar fiber surface and the nonpolar matrix, which causes clumping of the fibers and poor properties in the final product.

Kenaf woody core fibers have not been used as a reinforcing fiber in plastics, in part because of their lower aspect ratio compared to kenaf bast fibers, as well as poor interfacial adhesion between the polar fiber surface and polymer matrix.

Because of the high volume of inner woody core in the bast plant, it would be desirable to discover a means of using the woody core fibers for value-added composite materials. It would also be desirable to improve the interfacial adhesion between plant fibers and thermoplastic resins.

### SUMMARY OF THE INVENTION

A composite of woody core fibers coated with a binding agent and dispersed in a matrix of polyolefin can be used to make eco-friendly extruded or molded products.

In one embodiment, kenaf woody core particles are mixed with a binding agent and powdered polyolefin to form a kenaf-polyolefin powder mixture. The kenaf woody core particles have a moisture content of 6% or less and the powdered polyolefin has a particle size of −35 Tyler mesh. A composite article is formed from the kenaf-polyolefin powder mixture using extrusion or injection molding.

In another embodiment, kenaf woody core particles are mixed with a binding agent and polyolefin to form a polyolefin-fiber mixture having a kenaf woody core content in a range of from about 90 wt % to about 98 wt %. The kenaf woody core particles have a moisture content of 6% or less. The polyolefin-fiber mixture is extruded to form masterbatch pellets. The masterbatch pellets can be used to form polyolefin-fiber composite articles.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a block diagram of processes to form a polyolefin-woody core fiber composite according to the inventive concepts disclosed herein.

FIG. 2 shows a 90 to 98% plant-based masterbatch as in Example 3 appearing somewhat sandy and gritty.

FIG. 3 shows the extruder used in the pilot tests for making composite straws.

FIG. 4 shows composite black, blue and red straws produced in Example 4.

FIG. 5 shows an example of bulk production of composite straws containing 80% kenaf hurd.

FIG. 6 shows an example of straws extruded using a masterbatch produced as in Example 3 mixed with a polyethylene and polypropylene melt as in Example 5.

FIG. 7 shows an example composite container having 90% kenaf hurd and injection molded as in Example 6 using a polypropylene homopolymer.

FIG. 8 shows an example of light cream pellets containing kenaf hurd produced as in Example 7 and used for future production of polyethylene film.

FIG. 9 shows tan color composite pellets of polypropylene and 80% kenaf hurd.

FIG. 10 shows a darker brown composite pellet made of recycled polypropylene and 80% kenaf hurd.

### DETAILED DESCRIPTION

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed inventive concept(s) shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the presently disclosed inventive concept(s) have been described in terms of preferred embodiments, it will be apparent to those skilled in the art that variations may be applied to the articles and/or methods and in the steps or in the sequence of steps of the method described herein without departing from the concept, spirit, and scope of the presently disclosed inventive concept(s). All such similar substitutes and modifications apparent to those skilled in the art are deemed to be within the spirit, scope, and concept of the presently disclosed inventive concept(s).

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

All percentages used herein are to be interpreted as weight percentages unless indicated otherwise.

Over the past few decades there has been a growing interest in composites utilizing natural fibers from hemp, kenaf, and the like. The stalks of hemp, kenaf, and other fiber plants contain two main types of fiber: bast and hurd. Hurd, also referred to herein as woody core, or inner core, or inner woody core, comprises short fibers and is located in the core of the stem. Bast comprises long fibers and is found in the bark (skin) of the stalk. Prior art references to “fiber” are typically referring to the bast fiber. Bast fiber, also called phloem fiber, is collected from the phloem or bast surrounding the stem where it supports the conductive cells of the phloem and provides strength to the stem. Bast fibers obtained from plants such as flax, hemp, kenaf, jute and the like have been used for woven applications such as carpet, yarn and netting. Non-woven applications of bast hemp fiber include composite applications such as automobile door panels and headliners. Bast kenaf fibers have received attention for potential use as a reinforcing fiber in composite thermoplastics because of their superior toughness and high aspect ratio compared to other fibers. A single (bast) fiber of kenaf can have a tensile strength and modulus as high as 11.9 GPa and 60 GPa respectively. The fibril size and chemical content of a kenaf stem are shown in Table 1 below.

TABLE 1
Fiber Size and Content of the Kenaf Stem

| | Bark | Core |
|---|---|---|
| Fibril length, L (mm) | 2.22 | 0.75 |
| Fibril width, W (μm) | 17.34 | 19.23 |
| L/W | 128 | 39 |
| Lumen diameter (μm) | 7.5 | 32 |
| Cell wall thickness (μm) | 3.6 | 1.5 |
| Cellulose (%) | 69.2 | 32.1 |
| Lignin (%) | 2.8 | 25.21 |
| Hemicellulose (%) | 27.2 | 41 |
| Ash content (%) | 0.8 | 1.8 |

Other references describe kenaf bast as constituting 40% of the plant with individual fiber cells about 2-6 mm long and slender, with a 6.3 μm cell wall thickness. Conversely, the core is about 60% of the plant and has thick (about 38 μm) but short (0.5 mm) and thin-walled (3 μm) fiber cells.

For millennia, hemp was grown for bast fiber while the inner woody core or hurd was considered a waste by-product of bast production. Later, woody core fibers found product applications such as animal bedding, summer forage, and potting media. However, it has presently been discovered that woody core fiber can be incorporated in plastics to make thermoplastic composites.

An embodiment of the presently disclosed inventive concepts includes a composition comprising woody core fibers dispersed in a polymer matrix. The woody core fibers are coated with a binding agent such as a saccharide or polysaccharide to aid in dispersing the fibers into the polymer. In one embodiment, more than 50% of the fibers in the composition are woody core fibers and less than 50% of the fibers are bast fibers. In another embodiment, 90% or more of the fibers in the composition are woody core fibers and 10% or less are bast fibers. In yet another embodiment, the fibers in the composition are essentially all woody core fibers with essentially no bast fibers.

The woody core fibers derive from the stems or stalks of dicotyledonous plants. Nonlimiting examples of suitable plants include kenaf, hemp, jute, and flax. In one embodiment, the composition comprises kenaf woody core fibers.

The amount of woody core fibers in the composition can vary. In one embodiment, the woody core fibers are present in the composition in an amount ranging from about 25 wt % to about 90 wt %. In another embodiment, the woody core fibers are present in a masterbatch composition in an amount ranging from about 90 wt % to about 98 wt %.

To obtain the woody core fibers, harvested kenaf, hemp, and the like are decorticated to separate bast fiber from the hurd. Decortication processes vary and can be manual. But processes generally employ automated machinery that subjects the fiber plant to mechanical stresses that physically rupture the bond between the inner woody core and the bast. The machinery then separates the bast from the inner core. Another process commonly employed to separate bast from the inner woody core is that of “retting”, which is a process of submerging the plant stalks in water, and soaking them for a period of time to loosen the outer fibers from the other components of the stalk. Retting can also be done by letting the cut crop stand in the fields exposed to atmospheric moisture. Bacterial action attacks pectin and lignin, freeing the cellulose fibers. The stalks are then removed and washed and subjected to mechanical processing to remove the soft tissue and then dried. A process employing a combination of retting and decortication machinery may also be used to obtain bast fibers.

The woody (inner) core or hurds can be further processed by grinding which separates the woody core fibers and reduces the fiber size. Grinding equipment and methods are known and understood by those skilled in the art. For example, woody core fibers can be ground in a rotary mill or other rotary grinding equipment.

In one embodiment, woody core fibers in the composition have a fiber length of less than 550 μm. In another embodiment, the woody core fibers have a weight average length in a range of from about 60 μm to about 100 μm.

The woody core fibers can derive from hemp, kenaf, jute, flax, and the like. In one embodiment, the woody core fibers are kenaf woody core fibers.

One of the main disadvantages of incorporating natural fibers into a polymer matrix, is the lack of good interfacial adhesion between the fiber surface and the polymer. This results in poor properties in the final product. The poor interfacial adhesion is believed to be due to polar hydroxyl groups on the fiber surface which are actually repelled by the nonpolar matrix. Regardless of the mechanism, the inherent polar and hydrophilic nature of the natural fibers make it difficult to blend the fibers into a hydrophobic polyolefin matrix. However, it was discovered that this can be alleviated by coating the fibers with a binding agent such as a saccharide or polysaccharide. For example, the fibers can be mixed with a liquid starch prior to mixing with polyolefin pellets and the mixture can be extruded producing excellent composite properties.

Nonlimiting examples of other saccharides tested that provided good processing and good composite properties include corn starch in water and clear sugar concentrate in water. It is hypothesized that the saccharides and polysaccharides function as a coupling agent for the woody core fibers and the polyolefin resin.

When the polyolefin is pulverized prior to mixing with dried woody core fibers, and as described in detail hereinafter, it is not necessary to add a saccharide or polysaccharide binding agent. Excellent results are obtained when the woody core fibers are dried to 6% moisture or less and the polyolefin is pulverized to minus 35 mesh (Tyler) or to a particle size of 0.420 mm or less.

Nonlimiting examples of suitable polyolefins include polyethylene, polypropylene, and mixtures and copolymers thereof. The polyethylene used can be a high-density polyethylene (HDPE), a low-density polyethylene (LDPE), linear low-density polyethylene, and combinations thereof.

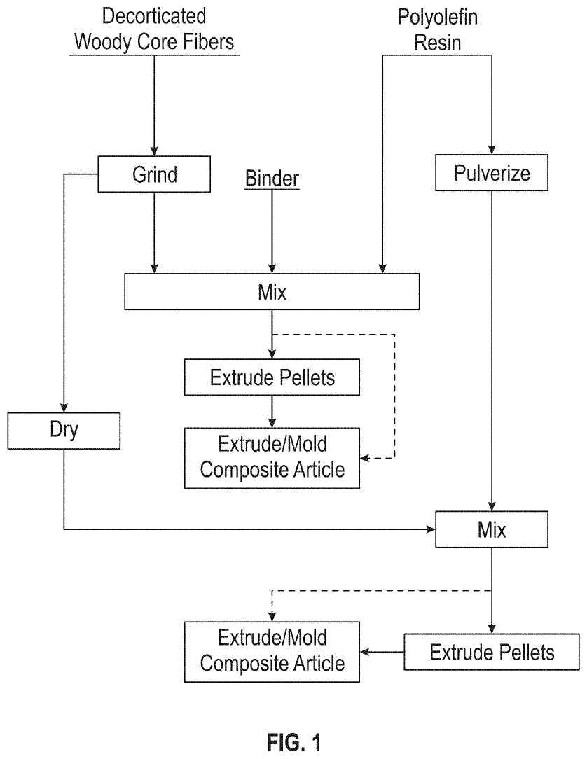

Turning now to FIG. 1, in one embodiment, decorticated woody core fibers are ground and mixed with a binding agent (for example a saccharide or polysaccharide binding agent) and with a polyolefin resin. While the polyolefin resin can be pulverized, it is not necessary. Addition of the binding agent allows the use of pellet-form or other unpulverized forms of polymer. The mixture can be extruded or injection molded using procedures known to those skilled in the art of forming thermoplastic composite pellets and shapes.

In one embodiment, the mixing step is conducted at ambient temperature. In another embodiment, the mixing step is conducted at a temperature in a range of from about 100° C. to about 200° C. In yet another embodiment, the mixing step is conducted at a temperature in a range of from about 135° C. to about 165° C.

In one embodiment, the polyolefin resin is pulverized and the woody core fibers are dried to 6% moisture or less prior to mixing, making addition of a binding agent unnecessary. For example, the polyolefin resin can be pulverized to form a −35 Tyler mesh powder. It is hypothesized that the increased surface area of the pulverized polyolefin combined with the decreased hydrophilicity of the dried woody core fibers provide sufficient coupling opportunity.

In one embodiment, the mixing of the dried woody core fibers and the polyolefin powder is conducted at a temperature in a range of from about 100° C. to about 200° C. In another embodiment, the same mixing step is conducted at a temperature in a range of from about 135° C. to about 165° C.

The heated mixture of woody core fibers, polyolefin, and optionally a saccharide binding agent are at least partially melted and formed to a composite pellet or other composite article. Processes for forming the composite shape include, but are not limited to extrusion and molding processes such as injection molding.

When composite pellets are formed, the composite pellets can be used to form other composite shapes.

### Example 1

Kenaf hurd was milled to a particle size of 1-550 μm. 1.2 lb of milled particles were mixed with 4 lbs of polylactic acid (PLA) and extruded to form a straw. The extrusion was repeated in a second test mixing 1.2 lb kenaf hurd particles with 4 lbs high-density polyethylene (HDPE). A third test mixed 1.2 lb kenaf hurd particles with 4 lbs of low-density polyethylene (LDPE). Higher concentrations of hurds were attempted; however, it was not possible to process higher than 30% biomaterial, and even then it was not evenly distributed. The tooling broke due to high back pressure from unmelted biomaterial. A redesign was necessary to continue testing. HDPE appeared to be the best carrier resin for consistent flow;

however, clumping of the biomaterial tore the straw during extrusion.

### Example 2

Kenaf hurd particles milled to a particle size of 1-550 μm were mixed with 2% to 10% liquid starch (STA-FLO™) to coat the fiber surfaces and further mixed with varying quantities of LDPE and extruded to form straws. Production was smooth; however, the straws produced were brittle.

### Example 3

Kenaf hurd particles (6 lb) were milled to a particle size range of 1-550 μm. The milled particles contained 8-12% moisture but were dried to 5% moisture or less and then mixed with 2% to 10% liquid starch (STA-FLO™) to coat the fiber surfaces and further mixed with small quantities of molten polyolefin. The mixture was pelletized in an extrusion type pelletizer to make a 90 to 98% plant-based masterbatch. FIG. 2 shows the masterbatch pellets appearing somewhat sandy and gritty.

### Example 4

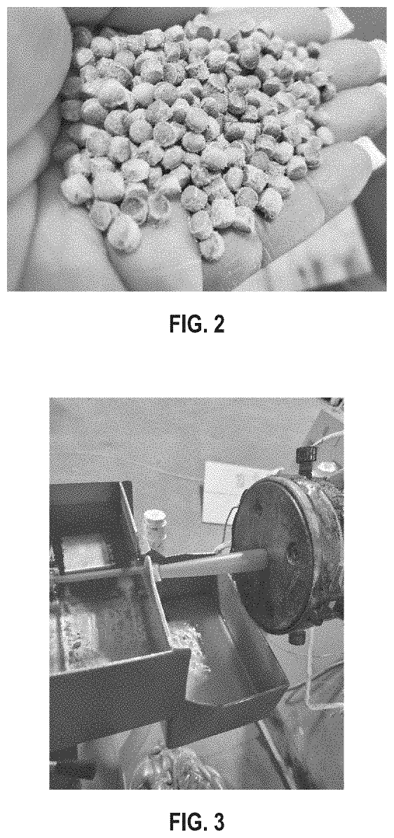

The masterbatch produced as in Example 3 above was mixed with a polyethylene and polypropylene melt at varying ratios and extruded to form straws. FIG. 3 shows the extruder used in the pilot tests. Composite straws showing essentially no tearing were produced having a plant content (kenaf hurd) of 20% up to 85%.

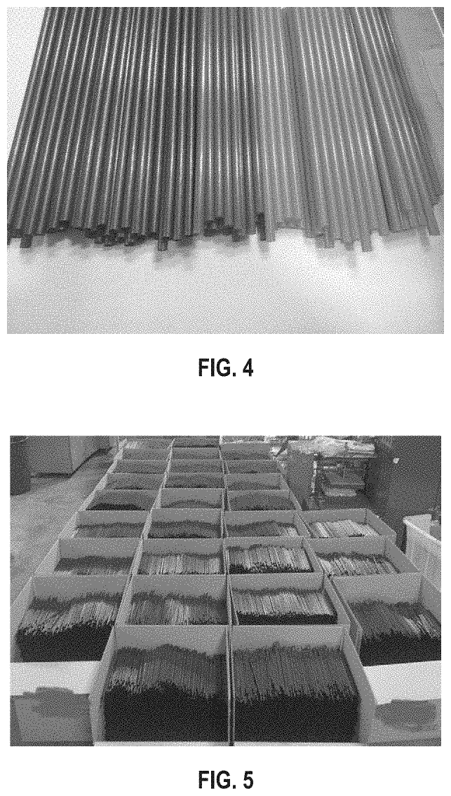

Different dyes or colorants were added to the mixer to make the composite black, blue and red straws shown in FIG. 4. These straws contained 80% kenaf hurd and were examined for strength and uniformity of fiber distribution. The straws produced were strong and showed good fiber distribution with little clumping. FIG. 5 shows a bulk production of composite straws containing 80% kenaf hurd.

### Example 5

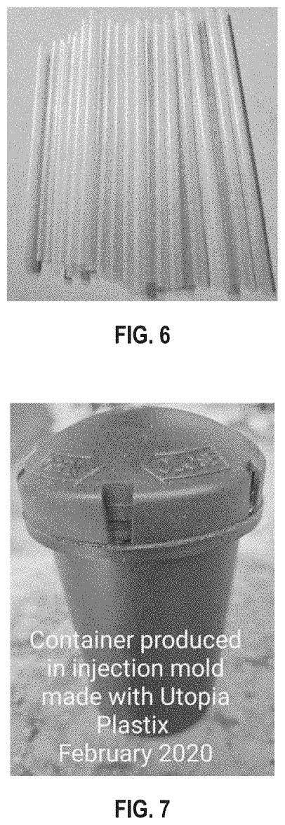

The masterbatch produced as in Example 3 above was mixed with a polyethylene and polypropylene melt and extruded to form straws having a plant content (kenaf hurd) of 65%. No colorant was added to the straws shown in FIG. 6.

### Example 6

The masterbatch produced as in Example 3 above was mixed with a polypropylene homopolymer and injection molded to produce composite containers as shown in FIG. 7. These composite containers have a plant content (kenaf hurd) of 90%. Combinations of polypropylene homopolymer, polypropylene co-polymer, and polyethylene were also molded to provide the properties (flexibility, stiffness, etc.) desired for different final products.

### Example 7

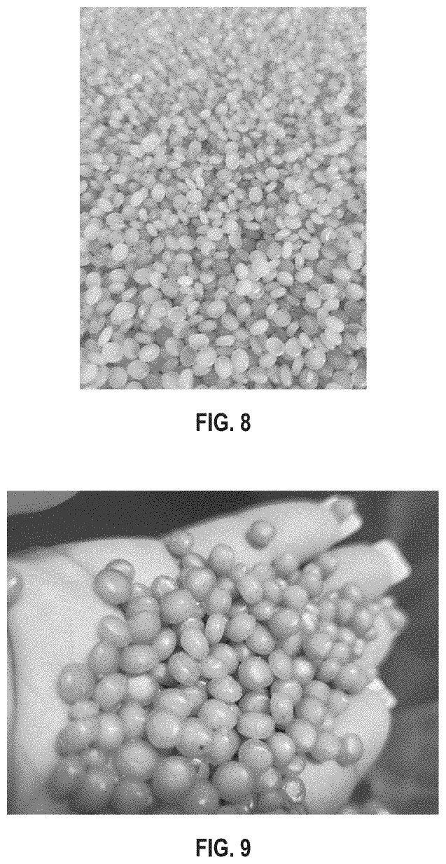

Some manufacturers prefer to use premixed plastics or composite plastics. To accommodate such, composite pellets were produced using a masterbatch produced as in Example 3 and mixed with the desired molten polymer. A light cream pellet shown in FIG. 8 was made using masterbatch as in Example 3 mixed with low-density polyethylene (LDPE). The LDPE composite pellets contained 70% kenaf hurd and could be used for production of polyethylene film.

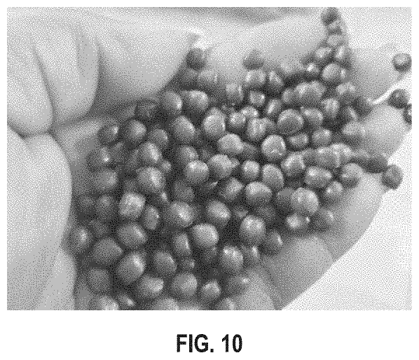

Other composite pellets were made using a masterbatch as in Example 3 and mixing with a molten polypropylene homo or copolymer. A tan polypropylene composite pellet containing 85% kenaf hurd is shown in FIG. 9. A darker brown pellet, also containing 85% kenaf hurd, is shown in FIG. 10. The darker brown pellets were made using recycled polypropylene.

Although the presently disclosed inventive concept(s) has been described in conjunction with the specific language set forth herein above, it is evident that many alternatives, modifications, and variations will be apparent to those skilled in the art. Accordingly, it is intended to embrace all such alternatives, modifications, and variations that fall within the spirit and broad scope of the presently disclosed inventive concept(s). Changes may be made in the construction and the operation of the various components, elements, and assemblies described herein, as well as in the steps or the sequence of steps of the methods described herein, without departing from the spirit and scope of the presently disclosed inventive concept(s).

What is claimed is:

1. A composition comprising woody core fibers at least partially coated with a binding agent and dispersed in a matrix of polyolefin.

2. The composition of claim 1, comprising essentially no bast fiber.

3. The composition of claim 1 or claim 2, wherein the woody core fibers comprise woody core from at least one of hemp, kenaf, jute, and flax.

4. The composition of claim 1 or claim 2, comprising kenaf woody core fibers.

5. The composition of claim 4, comprising about 20 wt % to about 90 wt % kenaf woody core fibers.

6. The composition of claim 4, comprising about 90 wt % to about 98 wt % kenaf woody core fibers.

7. The composition of claim 4, wherein the binding agent comprises a saccharide or a polysaccharide.

8. The composition of claim 4, wherein the binding agent comprises at least one of starch and sugar.

9. The composition of claim 4, wherein the polyolefin is selected from the group consisting of polyethylene, polypropylene, and combinations thereof.

10. An extruded product comprising the composition of claim 9.

11. A molded product comprising the composition of claim 9.

12. A process for making a composite article, the process comprising the steps of:
mixing kenaf woody core fibers with a powdered polyolefin to form a kenaf-polyolefin powder mixture, wherein the kenaf woody core fibers have a moisture content of about 6% or less, and wherein the powdered polyolefin has a particle size of −35 Tyler mesh; and
forming a composite article from the kenaf-polyolefin powder mixture using a process selected from extrusion and injection molding.

13. The process of claim 12, wherein the polyolefin is selected from the group consisting of polyethylene, polypropylene, and mixtures thereof.

14. The process of claim 12 or claim 13, wherein the step of mixing kenaf woody core fibers with the powdered polyolefin is conducted at a temperature in a range of about 135° C. to about 165° C.

15. A process comprising:
mixing milled kenaf woody core particles with a binding agent and polyolefin to form a polyolefin-fiber mixture having a kenaf woody core content in a range of about 90 wt % to about 98 wt %, wherein the kenaf woody core fibers have a moisture content of about 6% or less; and
extruding the polyolefin-fiber mixture to form masterbatch pellets.

16. The process of claim 15, wherein the polyolefin is selected from the group consisting of polyethylene, polypropylene, and mixtures thereof.

17. The process of claim 15 or claim 16, wherein the binding agent comprises at least one of sugar and starch.

18. The process of claim 17, further comprising the step of forming a composite article from a polyolefin and the masterbatch pellets using a process selected from extrusion and injection molding.
